(19) United States
(12) Patent Application Publication
(10) Pub. No.: US 2015/0032961 A1
(43) Pub. Date: Jan. 29, 2015

(54) System and Methods of Data Migration Between Storage Devices

(71) Applicant: Lexmark International Technologies S.A., Geneva (CH)

(72) Inventor: Ryan Timothy Sanford, South Saint Paul, MN (US)

(21) Appl. No.: 14/339,201

(22) Filed: Jul. 23, 2014

Related U.S. Application Data
(60) Provisional application No. 61/857,685, filed on Jul. 23, 2013.

(51) Int. Cl. G06F 3/06; G06F 12/08

(52) U.S. Cl. CPC G06F 3/0647; G06F 12/08; G06F 3/0619; G06F 3/067
USPC 711/118; 711/162

(57) ABSTRACT

A method of migrating data that includes determining one or more objects to be migrated from a source device to a destination device; adding the one or more objects to a queue used to migrate the one or more objects to the destination device, the queue having a pre-defined size; suspending the adding the one or more objects to the queue if a total size of the objects in the queue exceeds the pre-defined size of the queue; resuming the adding the one or more objects to the queue when the total size of the objects in the data structure no longer exceeds the pre-defined size of the queue, and migrating each of the one or more objects in the queue to the destination device.

### CROSS REFERENCES TO RELATED APPLICATIONS

Pursuant to 35 U.S.C. §119, this application claims the benefit of the earlier filing date of provisional application Ser. No. 61/857,685, filed Jul. 23, 2013, entitled “System and Methods for Data Migration Between Storage Devices,” the contents of which is hereby incorporated by reference herein in their entirety. This patent application is related to the U.S. patent application Ser. No. 14/315,096, and U.S. application Ser. No. 14/314,911, both entitled, “System and Methods of Data Migration Between Storage Devices,” and filed on Jun. 25, 2014, and assigned to the assignee of the present application.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Technical Field

The present disclosure relates generally to methods for migrating data between storage devices, and more particularly, efficient data migration between two storage devices.

2. Description of the Related Art

Data migration is the process of transferring or moving data from one storage location to another. With the increasing use and value of information, enterprises continue to seek reliable systems and methods to efficiently and quickly migrate data between two locations.

In some instances, reading objects to be migrated from a source device occurs at a faster and more efficient rate than writing those objects to a destination device. When this happens, a queue that stores the workload of objects to be migrated can rapidly grow, thereby consuming increasing amounts of system resources, such as random access memory (RAM). Space needed for a cache to hold the workload can also become consumed rapidly, which adds to the complexity and inefficiency of the migration process.

Accordingly, there is a need for a seamless data migration process that dynamically migrates objects from the source device to the destination device and takes into account the changes in workload sizes of the objects to be migrated.

### SUMMARY

A system and methods of migrating data from a source device to a destination device are disclosed. In one example embodiment, a method of migrating data includes determining one or more objects to be migrated from a source device to a destination device; adding the one or more objects to a queue used to migrate the one or more objects to the destination device, the queue having a pre-defined size; suspending the adding the one or more objects to the queue if a total size of the objects in the queue exceeds the pre-defined size of the queue; resuming the adding the one or more objects to the queue when the total size of the objects in the data structure no longer exceeds the pre-defined size of the queue, and migrating each of the one or more objects in the queue to the destination device.

In another example embodiment, a method for migrating data records includes identifying the data records to be migrated from a source device to a destination device; establishing a number of containers for holding the data records; adding the containers to a writer queue, the writer queue containing the containers having the data records to be migrated to the destination device; determining a current size of the writer queue; if the current size of the writer queue is greater than a pre-defined threshold size for the writer queue, suspending the adding the containers to the writer queue; if the current size of the writer queue is less than the predefined threshold size for the writer queue, continuing the adding the containers to the writer queue; and migrating the data records in the data containers included in the writer queue to the destination device.

From the foregoing disclosure and the following detailed description of various example embodiments, it will be apparent to those skilled in the art that the present disclosure provides a significant advance in the art of methods of migrating data records from a source device to a destination device. Additional features and advantages of various example embodiments will be better understood in view of the detailed description provided below.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 is an example embodiment of a system for performing an example migration of data from one device to another.

FIG. 2 is an example method of migrating data from a migration source device to a migration destination device with a writer queue throttle improvement.

### DETAILED DESCRIPTION OF THE DRAWINGS

It is to be understood that the disclosure is not limited to the details of construction and the arrangement of components set forth in the following description or illustrated in the drawings. The disclosure is capable of other example embodiments and of being practiced or of being carried out in various ways. For example, other example embodiments may incorporate structural, chronological, process, and other changes. Examples merely typify possible variations. Individual components and functions are optional unless explicitly required, and the sequence of operations may vary. Portions and features of some example embodiments may be included in or substituted for those of others. The scope of the disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Further, the use of the terms “a” and “an” herein do not denote a limitation of quantity but rather denote the presence of at least one of the referenced item.

In addition, it should be understood that example embodiments of the disclosure include both hardware and electronic components or modules that, for purposes of discussion, may be illustrated and described as if the majority of the components were implemented solely in hardware.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block or combinations of blocks in the diagrams discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, can be implemented by special purpose hardware-based computer systems that perform the specified functions or steps, or combinations of special purpose hardware and computer instructions.

Disclosed are a system and methods for migrating data from one storage device to another. One example method disclosed allows a migration tool to control the number of candidates to add to a queue for migrating from the source device to the destination device in order to avoid a large increase in the demand for resources in the system that performs the migration from the source device to the destination device.

For purposes of the present disclosure, it will be appreciated that the content may refer to files such as, for example, documents, image files, audio files, among others. Content may refer to paper-based records converted into digital files to be used by a computing device. Content may also refer to information that provides value for an end-user or content consumer in one or more specific contexts. Content may be shared via one or more media such as, for example, computing devices in a network.

In an example embodiment, content may refer to computerized medical records, or electronic medical records (EMR), created in a health organization, or any organization that delivers patient care such as, for example, a physician's office, a hospital, or ambulatory environments. EMR may include orders for drug prescriptions, orders for tests, patient admission information, imaging test results, laboratory results, and clinical progress information, among others.

Content may also refer to an electronic health record (EHR) which may be a digital content capable of being distributed, accessed or managed across various health care settings. EHRs may include various types of information such as, for example, medical history, demographics, immunization status, radiology images, medical allergies, personal states (e.g. age, weight), vital signs and billing information, among others. EHR and EMR may also be referred to as electronic patient record (EPR). The terms EHR, EPR, EMR, document, content, object and assets may be used interchangeably for illustrative purposes throughout the present disclosure.

In another example embodiment, content may also refer to DICOM images. DICOM is a standard or specification for transmitting, storing, printing and handling information in medical imaging. Medical imaging, as will be known in the art, may refer to a process and/or technique used to generate images of the human body, or parts or functions thereof, for medical and/or clinical purposes such as, for example, to diagnose, reveal or examine a disease. The standard set by DICOM may facilitate interoperability of various medical imaging equipment across a domain of health enterprises by specifying and/or defining data structures, workflow, data dictionary, and compression, among other things, for use to generate, transmit and access the images and related information stored on the images. DICOM content may refer to medical images following the file format definition and network transmission protocol as defined by DICOM. DICOM content may include a range of biological imaging results and may include images generated through radiology and other radiological sciences, nuclear medicine, thermography, microscopy, and medical photography, among many others. DICOM content may be referred to hereinafter as images following the DICOM standard, and non-DICOM content for other forms and types of content, as will be known in the art.

Content may be generated and maintained within an institution such as, for example, an integrated delivery network, hospital, physician's office or clinic, to provide patients and health care providers, insurers or payers access to records of a patient across a number of facilities. Sharing of content may be performed using network-connected enterprise-wide information systems, and other similar information exchanges or networks, as will be known in the art.

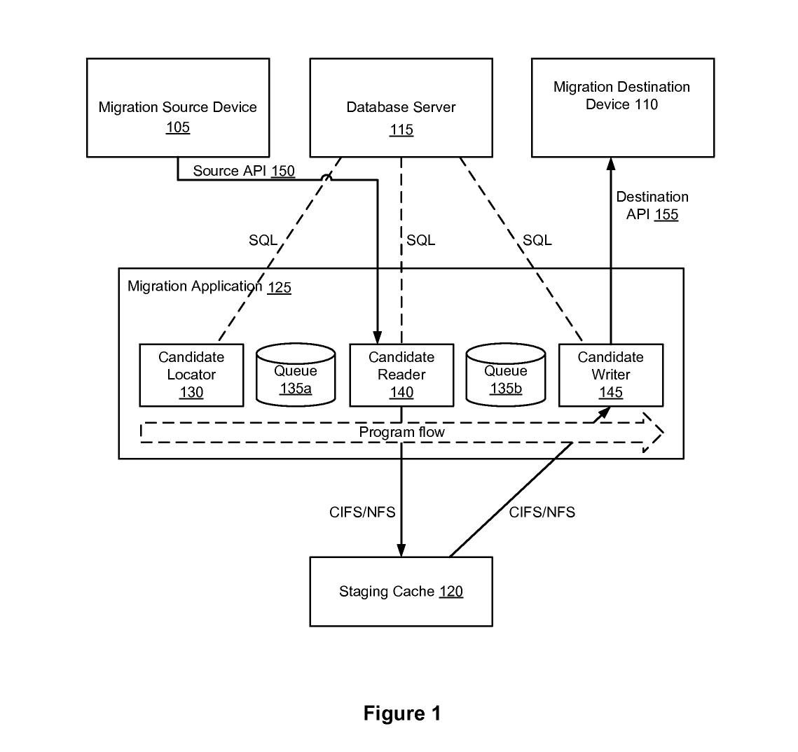

FIG. 1 shows an example system for performing the method of seamless data migration between one or more storage devices. System 100 includes a migration source device 105, a migration destination device 110, a database server 115, a staging cache 120, and a migration application 125. Migration application 125 includes one or more components such as a candidate locator 130, a reader queue 135a, a writer queue 135b, a candidate reader 140 and a candidate writer 145.

Migration source device 105 and migration destination device 110 are computer readable storage media for storing content from at least one content source. Migration source device 105 and migration destination 110 may be databases for storing content to be used by at least one enterprise or organization. Each of migration source device 105 and migration destination device 105 may be storage platforms for storing, archiving and accessing content. In one example embodiment, migration source device 105 and migration destination device 110 may be cloud storage platforms.

Migration source device 105 and migration destination device 110 may be content-addressable storage (CAS) devices. CAS devices refer to devices that store information that are retrievable based on the content of the information, and not based on the information's storage location. CAS devices allow a relatively faster access to fixed content, or stored content that is not expected to be updated, by assigning the content a permanent location on the computer readable storage medium. CAS devices may make data access and retrieval up-front by storing the object such that the content cannot be modified or duplicated once it has been stored on the memory. In alternative example embodiments, storage devices may be Grid, NAS, and other storage systems as will be known in the art.

Examples of migration source device 105 and migration destination device 110 include Atmos®, StorageGRID®, Sonas®, Nirvanix®, among many others. Any other forms and types of storage devices and platforms may be used as at least one of migration source device 105 and migration destination device 110, as will be known in the art.

Database server 115 may be a computing device that serves as a server for storing one or more databases. Database server 115 may be used to store one or more candidates for migration, which will be used in conjunction to a method as will be discussed in greater detail below. In one example embodiment, database server 115 may be a SQL database server.

Staging cache 120 may be a network-attached storage (NAS) device used by migration application 125. Staging cache 120 may be a file-level computer readable storage medium that is connected to a computing device network. Staging cache 120 may provide data access to one or more group of clients which may or may not use different types of computational units. In one example embodiment, staging cache 120 may be a specialized NAS device having a customized hardware, software, or a configuration of any of the two elements, for use in the seamless migration of data.

In another example embodiment, staging cache 120 may be one of a plurality of networked appliances that contain at least one hard drive and provide access to content using network file sharing protocols such as, for example, Server Message Block (SMB), Network File Storage (NFS), among many others. In yet another example embodiment, staging cache 120 may be a computing device connected to the network illustrated in system 100 that provides file-based storage service to other devices on system 100.

Migration application 125 may be a subsystem containing one or more computing devices connected to each other by one or more communication links, as will be known in the art. Migration application 125 may include a candidate locator 130, a reader queue 135a, a writer queue 135b, a candidate reader 140 and a candidate writer 145 that perform one or more methods for migrating data from migration source device 105 to migration destination device 110. In one example embodiment, candidate locator 130, reader queue 135a, writer queue 135b, candidate reader 140 and/or candidate writer 145 may not be part of migration application 125 but rather are communicatively coupled or connected to migration application 125, or to at least one computing device in migration application 125. In one alternative example embodiment, candidate locator 130, reader queue 135a, writer queue 135b, candidate reader 140 and candidate writer 145 may be software applications running on migration application 125.

In yet another example embodiment, candidate locator 130, candidate reader 140 and candidate writer 145 may be three types of worker threads and reader queue 135a and writer queue 135b may act as buffers between the worker threads to reduce the amount of time a worker thread type is idle, as well as to allow container sizes to change between migration source device 105 and migration destination device 110.

Candidate locator 130 may query database server 115 for candidate assets which are stored on migration source device 105 and need to be migrated to migration destination device 110. In an example embodiment, candidate locator 130 may be one thread in migration application 125. Reader queue 135a may be a queue for candidate reader 140.

Candidate reader 140 may be a configurable number of threads in migration application 125. The number of threads in candidate reader 140 may be configured using a parameter in a settings file and/or function included in migration application 125 (not shown). Candidate reader 140 picks up candidates in reader queue 135a, reads the asset containers off of migration source device 105, writes the asset containers to staging cache 120, updates database server 115 to reflect the new location of the assets, and puts the assets in writer queue 135b, for access by candidate writer 145.

Candidate writer 145 may be a configurable number of threads in migration application 125. The number of candidate writer 145 threads may be configured using a parameter in a settings file and/or a function of migration application 125 (not shown). Candidate writer 145 picks up candidates from writer queue 135b, builds a new container and writes the new container to migration destination device 110, removes the assets from the staging cache 120 and updates database server 115 to reflect the new location of the assets.

Migration source device 105 may send data to be migrated to candidate reader 140 of migration application 135 using one or more functions by a source application programming interface (API). Source API may be a specification of one or more data structures, variables, routines and variables provided by migration source device 105 and may vary based on the type of migration source device 105 used in system 100.

Migration destination device 110 may also receive the data to be migrated from candidate writer 145 using one or more functions by a destination API 155. Similar to source API, destination API may be a specification provided by migration destination device 110 and is based on the type of device used.

Communication between each of candidate locator 130, candidate reader 140 and candidate writer 145 to database server 115, respectively, may be performed using one or more SQL functions. It will be appreciated that SQL is used for illustrative purposes and other types of communication between one or more threads and a database server may be used.

Candidate reader 140 may transmit candidates to staging cache 120 through Common CIFS and/or NFS protocols. Staging cache 120 may also transmit candidates to candidate writer 145 for writing to migration destination device 110 using CIFS or NFS. CIFS and NFS are different standards for computing devices to share files across a network. The use of CIFS and NFS to transfer or share files in system 100 is illustrative and other file sharing standards and protocols may be used.

Each of the components in system 100 may include one or more processors communicatively coupled to a computer readable storage medium having computer executable program instructions which, when executed by the processor(s), cause the processor(s) to perform the steps described herein. The storage medium may include read-only memory (ROM), random access memory (RAM), non-volatile RAM (NVRAM), optical media, magnetic media, semiconductor memory devices, flash memory devices, mass data storage devices (e.g., a hard drive, CD-ROM and/or DVD units) and/or other memory as is known in the art. The processor(s) execute the program instructions to receive and send electronic medical images over a network. The processor(s) may include one or more general or special purpose microprocessors, or any one or more processors of any kind of digital computer. Alternatives include those wherein all or a portion of the processor(s) is implemented by an application-specific integrated circuit (ASIC) or another dedicated hardware component as is known in the art.

The components in system 100 may be connected in a local area network (LAN) through one or more communication means in order to transmit and request content between each other. Other networks such as, WAN, wireless, among others, may also be utilized, as will be known in the art, to connect the computing devices in the system.

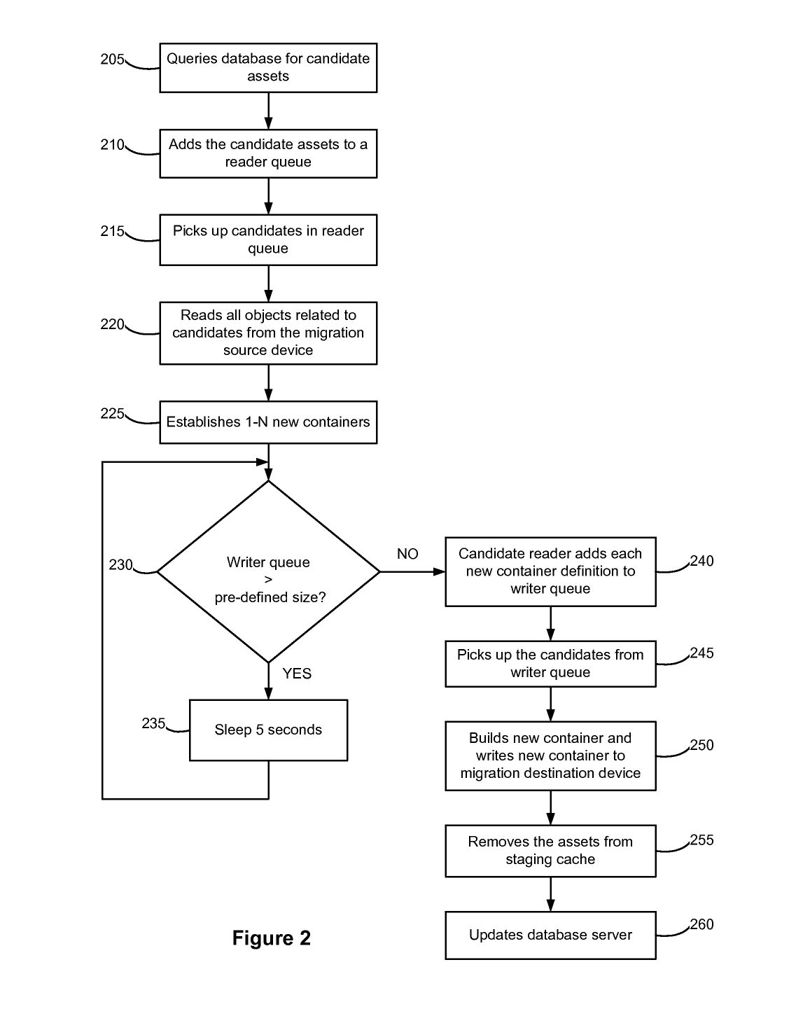

FIG. 2 is one example method 200 of migrating data from migration source device 105 to migration destination device 110 with a writer queue throttle improvement. The method includes reading candidates from migration source device 105, establishing 1-to-N new containers corresponding to the candidates, determining if writer queue 135b contains candidates greater than ten times the number of configured candidate writer 145 threads and adding each new container definition to writer queue 135b. Method 200 allows migration application 125 to dynamically control the number of candidates to be written to writer queue 135b by limiting the size of writer queue 135b. For illustrative purposes in example method 200, the pre-defined size of writer queue 135b is set to 10 times the number of configured candidate writer 145 threads. However, it will be appreciated by those skilled in the art that in other example embodiments, the size of writer queue 135b may be set to another pre-defined size.

Method 200 may be performed using the example pseudo-code as follows:

| | |
|---|---|
| 1. | Candidate reader reads all related objects from migration |
| | source device and establishes 1 to N new containers. |
| 2. | While writer queue contains greater than 10 * number of |
| | configured candidate writer threads |
| | 2.1. Sleep 5 seconds |
| 3. | Candidate reader adds each new container definition to the |
| | writer queue |

At block 205, candidate locator 130 queries database server 115 for candidate assets stored on migration source device 105 that need to be migrated to migration destination device 110. Candidate locator 130 then adds the candidate assets to reader queue 135a (at block 210). Candidate reader 140 then picks up candidates in reader queue 135a, reads all objects related to the candidates from migration source device 105 and establishes 1-to-N new containers (at blocks 215, 220, 225, respectively). N refers to the number of candidate assets determined to be migrated to migration destination device 110.

At block 230, the current size of writer queue 135b is checked. If the current size of writer queue 135b is greater than the example pre-defined size of 10 times the number of configured candidate writer threads, migration application 125 is set to sleep for a predetermined or preset amount of time which, for illustrative purposes, is 5 seconds (at block 235). Sleeping refers to a suspension in the adding of candidate assets to writer queue 135b. The number of configured candidate writer threads may refer to the number of candidate assets to be migrated to migration destination device 110.

At block 240, if the current size of writer queue 135b is less than or equal to the example pre-defined size of 10 times number of configured candidate writer threads, candidate reader 140 adds each new container definition to writer queue 135b for writing to migration destination device 110.

As discussed above with reference to FIG. 1, candidate writer 145 then picks up the candidates from writer queue 135b (at block 245), builds a new container and writes the new container to migration destination device 110 (at block 250), removes the assets from the staging cache 120 (at block 255) and updates database server 115 to reflect the new location of the assets (at block 260).

It will be understood that the example applications described herein are illustrative and should not be considered limiting. It will be appreciated that the actions described and shown in the example flowcharts may be carried out or performed in any suitable order. It will also be appreciated that not all of the actions described in FIG. 2 need to be performed in accordance with the embodiments of the disclosure and/or additional actions may be performed in accordance with other embodiments of the disclosure.

Many modifications and other example embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of migrating data, comprising:
determining one or more objects to be migrated from a source device to a destination device;
adding the one or more objects to a data structure used to migrate the one or more objects to the destination device, the data structure having a pre-defined size;
suspending the adding the one or more objects to the data structure if a total size of the objects in the data structure exceeds the pre-defined size of the data structure;
resuming the adding of the one or more objects to the data structure when the total size of the objects in the data structure no longer exceeds the pre-defined size of to the data structure; and
migrating each of the one or more objects in the data structure to the destination device.

2. The method of claim 1, further comprising removing each of the one or more objects from the data structure once the one or more objects is migrated to the destination device.

3. The method of claim 1, wherein the suspending the adding the one or more objects to the data structure comprises determining if a total number of objects in the data structure is greater than the pre-defined size of the data structure.

4. The method of claim 1, wherein the suspending the adding of the one more objects to the data structure occurs for a predetermined amount of time.

5. The method of claim 1, wherein the adding the one or more objects to the data structure includes adding the one or more objects to a cache.

6. The method of claim 1, wherein the migrating each of the objects in the data structure to the destination device occurs when the total size of the objects in the data structure equals the pre-defined size of the data structure.

7. A method for migrating data records, comprising:
identifying the data records to be migrated from a source device to a destination device;
establishing a number of containers for holding the data records;
adding the containers to a writer queue, the writer queue containing the containers having the data records to be migrated to the destination device;
determining a current size of the writer queue;
if the current size of the writer queue is greater than a pre-defined threshold size for the writer queue, suspending the adding the containers to the writer queue;
if the current size of the writer queue is less than the predefined threshold size for the writer queue, continuing the adding the containers to the writer queue; and
migrating the data records in the data containers included in the writer queue to the destination device.

8. The method of claim 7, wherein the number of containers corresponds to the number of data records to be migrated.

9. The method of claim 7, wherein the current size refers to a number of containers added to the writer queue at a time the size of the writer queue is checked.

10. The method of claim 7, wherein the suspending the adding the containers to the writer queue is performed for a specified time.

11. The method of claim 10, wherein the suspending the adding the containers to the queue for the specified time is repeatedly performed until the current size of the writer queue is less than the predefined threshold size for the writer queue.

12. The method of claim 7, wherein the migrating the data records in the containers included in the writer queue to the destination device includes deleting the migrated data records from the writer queue.

13. A non-transitory computer readable storage medium having one or more instructions for migrating data, the instructions including:
determining one or more objects to be migrated from a source device to a destination device;
adding the one or more objects to a queue used to migrate the one or more objects to the destination device, the queue having a pre-defined size;
suspending the adding the one or more objects to the queue if a total size of the objects in the queue exceeds the pre-defined size of the queue;
resuming the adding of the one or more objects to the queue when the total size of the objects in the queue no longer exceeds the pre-defined size of the queue; and
migrating each of the one or more objects in the queue to the destination device.

14. The non-transitory computer readable storage medium of claim 13, further comprising an instruction for removing each of the one or more objects from the queue once the one or more objects is migrated to the destination device.

15. The non-transitory computer readable storage medium of claim 13, wherein the one or more instructions for suspending the adding the one or more objects to the queue includes one or more instructions for determining if a total number of objects in the queue is greater than the pre-defined size of the queue.

16. The non-transitory computer readable storage medium of claim 13, wherein the one or more instructions for suspending the adding the one or more objects to the queue is performed for a preset amount of time.

17. The non-transitory computer readable storage medium of claim 16, further comprising one or more instructions for determining, after the preset amount of time, if a total size of the objects in the data structure exceeds the pre-defined size of the data structure.

18. The non-transitory computer readable storage medium of claim 16, further comprising one or more instructions for repeating the determining, after each additional preset amount of time, if a total size of the objects in the data structure exceeds the pre-defined size of the data structure.

19. The non-transitory computer readable storage medium of claim 13, wherein the one or more instructions for the adding the one or more objects to the queue includes an instruction for adding the one or more objects to a cache.

20. The non-transitory computer readable storage medium of claim 13, wherein the one or more instructions for the migrating each of the one or more objects in the queue to the destination device includes an instruction to perform the migrating when the total size of the objects in the queue equals the pre-defined size of the queue.
